(19) United States
(12) Patent Application Publication
(10) Pub. No.: US 2019/0393589 A1
(43) Pub. Date: Dec. 26, 2019

(54) LOW PROFILE ANTENNA - CONFORMAL ONE DIMENSIONAL

(71) Applicant: Antenum LLC, Merrimack, NH (US)

(72) Inventors: John T. Apostolos, Lyndeborough, NH (US); William Mouyos, Windham, NH (US)

(21) Appl. No.: 16/456,281

(22) Filed: Jun. 28, 2019

Related U.S. Application Data
(63) Continuation-in-part of application No. 16/179,069, filed on Nov. 2, 2018.
(60) Provisional application No. 62/692,065, filed on Jun. 29, 2018.
(60) Provisional application No. 62/733,162, filed on Sep. 19, 2018.
(60) Provisional application No. 62/624,714, filed on Jan. 31, 2018.
(60) Provisional application No. 62/584,966, filed on Nov. 13, 2017.
(60) Provisional application No. 62/581,110, filed on Nov. 3, 2017.

(51) Int. Cl. H01Q 1/32; H01Q 21/28

(52) U.S. Cl. CPC H01Q 1/32; H01Q 21/28

(57) ABSTRACT

An antenna array consists of multiple sub-arrays of planar, rectangular conductive patches disposed over a cavity to provide a volumetric antenna array. Each sub-array consist of multiple patch elements, arranged typically in a square or rectangular pattern. Multiple sub-arrays are further arranged along a one-dimensional row, to provide one or more unit cells. Adjacent sub-arrays in a row may be oriented at 45 degrees with respect to one another. The assembly provides a wide bandwidth, orientation dependent, directional antenna via volumetric radiating elements that can be conformal to exterior surface(s) of a vehicle such as a roof or trunk or roll bar of a passenger car.

### CROSS REFERENCE TO RELATED APPLICATIONS

This patent application claims priority to a co-pending U.S. Provisional application entitled “Low Profile Antenna—Conformal One Dimensional”, Ser. No. 62/692,065 filed Jun. 29, 2018 (Attorney Docket Number 100R), and claims priority to a co-pending U.S. Application entitled “SMART ANTENNA FOR IN-VEHICLE APPLICATIONS THAT CAN BE INTEGRATED WITH TCU AND OTHER ELECTRONICS”, Ser. No. 16/179,069 filed Nov. 2, 2018 (Attorney Docket Number 111052-0096U). This application also relates to a co-pending U.S. patent application entitled “Low Profile Antenna—Conformal”, Ser. No. 15/861,749 filed Jan. 4, 2018 (Attorney Docket Number 111052-0095U) and relates to a co-pending U.S. Application entitled “SMART ANTENNA FOR IN-VEHICLE APPLICATIONS THAT CAN BE INTEGRATED WITH TCU AND OTHER ELECTRONICS”, Ser. No. 16/179,069 filed Nov. 2, 2018 (Attorney Docket Number 111052-0096U). The entire contents of each of the above applications are hereby incorporated by reference.

### BACKGROUND

### Technical Field

This patent application relates to antennas and more particularly to a low-profile, conformal antenna array suitable for operating across a wide range of frequencies including AM/FM, 3G/4G, cellular, Wi-Fi, Bluetooth, GPS, satellite radio, and even proposed 5G wireless and vehicle-to-vehicle bands.

### SUMMARY

Miniaturized antennas can be provided using arrays of planar, volumetric conductors. By arranging these components in an appropriate configuration, the electrical properties of the antenna can be passively and/or automatically optimized over a wide bandwidth. This approach is particularly useful in vehicle applications since no part of the antenna needs to protrude beyond the skin of the vehicle.

An antenna array constructed in accordance with the teachings herein consists of multiple sub-arrays of planar, rectangular conductive patches disposed over a cavity to provide a volumetric antenna array. Each sub-array may consist of four patch elements, arranged typically in a square or rectangular pattern. Multiple sub-arrays may be further arranged along a one-dimensional row (or along a line), to provide one or more unit cells. Adjacent sub-arrays in a row may be oriented at 45 degrees with respect to one another.

The resulting structure may respond to Right-Hand Circularly Polarized (RHCP) and/or Left Hand Circularly Polarized (LHCP) energy with separate ports for each polarization. Diversity may be provided by generating orthogonal sine and cosine beams which may be created by subtracting diagonally juxtaposed elements. Operating modes may provide four orthogonal, simultaneous, unidirectional beams 0, 90, 180, and 270 degrees at the RHCP and LHCP ports.

The low-profile structure may be located in close proximity to or conformal with the sheet metal of a vehicle roof, or trunk, or roll bar and/or integrated within a non-metallic radome.

### BRIEF DESCRIPTION OF THE DRAWINGS

The description below refers to the accompanying drawings, of which:

FIG. 1 shows a unit cell consisting of five sub-arrays.

FIG. 2 is another arrangement consisting of multiple unit cells.

FIG. 3 shows the structure of FIG. 1 arranged over a ground plane and conformal to a vehicle surface.

### DETAILED DESCRIPTION OF AN EMBODIMENT

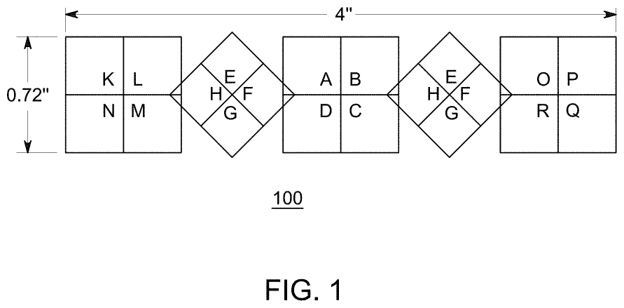

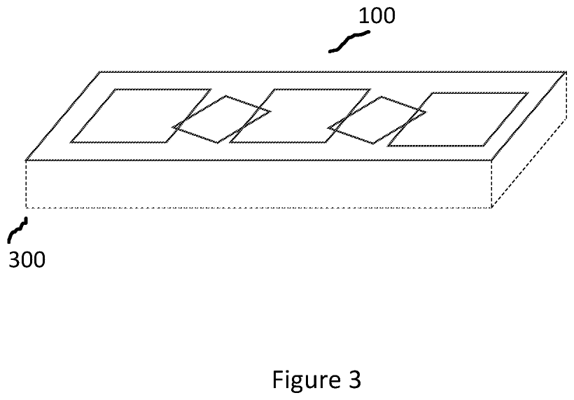

FIG. 1 is a schematic view of an embodiment of a unit cell 100 component of a Low Profile, Conformal antenna (referred to as a LOPAC or CALPRO antenna structure herein). The unit cell consists of a set of five sub-arrays disposed over one or more cavities, with FIG. 3 being one example of the unit cell 100 disposed over a cavity 300. Each sub-array consists of four voumetric elements, such as planar conductive surfaces or patches located over the cavity.

The individual radiating patches are typically arranged in groups of four to provide for orientation independent volumetric, superdirective antennas. This type of antenna is described in our previous patents such as U.S. Pat. No. 9,147,936 entitled “Low-Profile, Very Wide Bandwidth Aircraft Communications Antennas Using Advanced Ground-Plane Techniques,” as well as U.S. patent application Ser. No. 15/362,988 filed Nov. 29, 2016 entitled “Super Directive Array of Volumetric Antenna Elements for Wireless Device Applications,” and U.S. patent application Ser. No. 15/861,749 filed Jan. 4, 2018 entitled “Low Profile Antenna—Conformal”, and U.S. Provisional Patent Application No. 62/584,966 filed Nov. 13, 2017 entitled “Improved Low Profile Antenna—Conformal” the entire contents of all of which are hereby incorporated by reference.

The structure 100 shown is thus similar to that described in the above-referenced patents and co-pending patent applications, but with some differences. For example, a given sub-array, such as the left-most one shown, has a neighboring sub-array that is diagonally rotated. That is, each sub-array is rotated at a 45 degree angle with respect to its immediate neighboring sub-array. Although not shown in this figure, as with the embodiments described in the other pending patent applications, a number of frequency selective coupling elements such as meanderlines may connect the patches in each sub-array to one another and/or to the surrounding conductive surfaces, which may be the surfaces of a vehicle. These selective couplings are for tuning the structure across many different frequency bands.

In some arrangements, selected radiators may slightly physically overlap with radiators in their immediate neighboring sub-array.

The antenna array can be configured for operating across a wide range of frequencies including AM/FM, 3G/4G, cellular, Wi-Fi, Bluetooth, GPS, satellite radio, and even proposed 5G wireless and vehicle-to-vehicle bands. For example, selectively activating sets of the radiating patches in each unit cell may enable operation in these different frequency bands. Note the letters labelling each radiating element in the sub-arrays. For a unit cell sized as shown (a width of approximately 4 inches and height of 0.72 inches) actively coupling elements A, B, C, D to a radio transceiver provides operation in the 600-3800 MHz band, actively coupling elements E, F, G, H to a transceiver provides operation from 3800-6000 MHz, and actively coupling elements O, P, Q, R and K, L, M, N to a transceiver provides operation in the 1500-3800 MHz band.

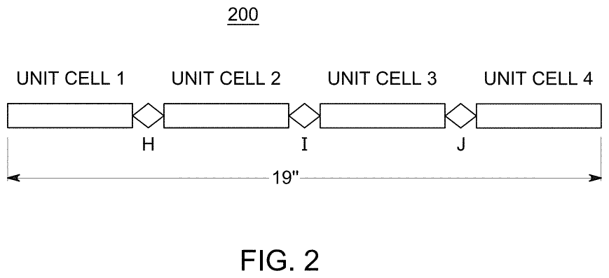

FIG. 2 shows a structure 200 where multiple unit cells 100 are combined to provide additional operating modes. This example structure 200 combines four unit cells 100 to provide a linear array of radiators in each of several operating bands. For example, all of the A,B,C,D radiators in all four unit cells are activated when operating in the 600-3800 MHz band. Elements E,F,G,H in all four unit cells provides operation from 3800-6000 MHz, and coupling all elements O,P,Q,R and K, L, M, N in all four unit cells provides operation in the 1500-3800 MHz band.

Sub-arrays (labelled H, I, J) rotated at 45 degrees are disposed between adjacent unit cells. The sub-arrays H, I, and J are coupled to transceivers to operate in the GPS, GNSS, or SDARS bands.

Individual sub-arrays can be further connected to operate with linear or horizontal polarizations. Circular polarization can be provided in an end-fire configuration.

Possible operating modes include
4×4 Multiple Input Multiple Output (MIMO) using 4 unit cells (e.g., FIG. 2) with linear polarization
8×8 MIMO using four unit cells (e.g., FIG. 2) with circular polarization
2×2 MIMO using a unit cell with an orthogonal “figure of 8” shaped elements
Unit cell with a linear phased array (using circular or linear polarization end-fire to broadside)

FIG. 3 shows the low-profile structures 100, 200 may be located over a cavity 300. The cavity may be formed within or or conformal to the sheet metal of a vehicle roof, or trunk, or roll bar and/or integrated within a non-metallic radome.

We have described a single assembly that is conformal antenna having a low profile that consists of nested orientation-independent sub-arrays. The structure can respond to right-hand circulay polarized and left-hand circulay polarized beams simultaneously, providing separate I/O ports for each polarization. Diversity can be provided with simultaneous bidirectional orthogonal sine and cosine beams created by subtracting the diagonally opposite radiators.

While various apparatus and methods have been particularly shown and described with references to example embodiments thereof, it will be understood by those skilled in the art that various changes in form and details may be made therein without departing from the scope of the invention(s) encompassed by the appended claims.

What is claimed is:

1. An antenna for use in a vehicle comprising:
a cavity having conductive walls;
a plurality of radiating surfaces disposed in a reference plane located above the cavity, such that each radiating surface comprises a quadrilateral surface having four sides, with a group of four quadrilateral surfaces comprising an orientation independent sub-array, and such that a plurality of sub-arrays are disposed in groups to thereby provide a unit cell, with adjacent sub-arrays rotated at 45 degrees with respect to one another, and
a plurality of frequency dependent couplings, each frequency dependent coupling disposed between a respective one of the radiating surfaces of the selected orientation-independent radiator and the other orientation-independent radiator and/or a ground plane element.
